(19) United States
(12) Patent Application Publication
(10) Pub. No.: US 2024/0086570 A1
(43) Pub. Date: Mar. 14, 2024

(54) TECHNOLOGIES FOR USE OF OBSERVABILITY DATA FOR DATA PRIVACY, DATA PROTECTION, AND DATA GOVERNANCE

(71) Applicant: Relyance Inc., Mountain View, CA (US)

(72) Inventors: Abhishek SHARMA, Mountain View, CA (US); Rahul Dilip JAGAD, Cupertino, CA (US)

(21) Appl. No.: 18/097,422

(22) Filed: Jan. 16, 2023

Related U.S. Application Data
(60) Provisional application No. 63/405,489, filed on Sep. 12, 2022.

(51) Int. Cl. G06F 21/62

(52) U.S. Cl. CPC G06F 21/6245

(57) ABSTRACT

Use of observability data (metrics, logs, and traces) generated by a monitoring system that monitors a codebase of an organization computing system as code is executed is described herein, where the observability data is used to perform an operation pertaining to at least one of data privacy, data protection, or data governance.

### RELATED APPLICATION

This application claims priority to U.S. Provisional Patent Application No. 63/405,489, filed on Sep. 12, 2022, and entitled “TECHNOLOGIES FOR USE OF OBSERVABILITY DATA FOR DATA PRIVACY, DATA PROTECTION, AND DATA GOVERNANCE”, the entirety of which is incorporated herein by reference.

### BACKGROUND

Organizations are building increasingly complex computer-implemented systems. In an example, a computing system of an organization may include proprietary code generated by developers employed by the organization, where the code may be in multiple different programming languages. The proprietary code, when compiled and executed, may correspond to computer-executable modules that consume data from and/or pass data to other computer-executable modules (where, for example, a computer-executable module may be a microservice, a portion of monolithic code, etc.). In addition, one or more of the computer-executable modules can consume data from and/or pass data to computing systems of third parties (where the third parties are sometimes referred to as “vendors”). The computing systems of the third parties may then process data received from the computer-executable modules referenced above in a manner that is not transparent to the organization. Modern organizations also use large scale open-source self-hosted tools and infrastructure for data processing and storage.

As a consequence of the complexities of modem organization computing systems, and further as a consequence of these computing systems being subjected to frequent change, understanding what types of data are being passed to and consumed by computer-executable modules and third-party computing systems, and also understanding how certain types of data flow between computer-executable modules and third-party computing systems, is incredibly challenging. In an example, a data protection officer (DPO) or other privacy, security, data governance, or other individual of an organization (collectively referred to as the “officer”) is tasked with ensuring that the organization, when processing personal data (data related to a person, persons, household, etc., including deidentified data that relates to a person, persons, household, etc.), does not violate data privacy policies, statutes, and/or regulations. Thus, the officer must not only be up to date on current policies, statutes, and regulations related to data privacy, but the officer must also be aware of how personal data is processed in the computing system of the organization.

Conventionally, there are no computer-implemented tools that are configured to assist an officer with identifying that personal data is processed by computing systems of an organization, how personal data flows between computing systems or processes of the organization, and/or whether or how personal data flows to or from computing systems of vendors that are associated with the organization. Currently, there are computer-implemented tools that generate observability data, where the observability data is indicative of performance pertaining to a computing system of an organization. For example, the observability data can be employed to alert an analyst when one or more microservices become active, when one or more services have gone offline, and so forth. The observability data generated by these computer-implemented tools, however, has not been employed to inform an officer that a computing system of an organization or a computing system of a vendor of the organization processes personal data of users.

### SUMMARY

The following is a brief summary of subject matter that is described in greater detail herein. This summary is not intended to be limiting as to the scope of the claims.

Described herein are computer-implemented technologies related to employment of observability data (generated by a monitoring service) to generate outputs related to data privacy, data protection, and/or data governance. With more particularity, an organization may employ a monitoring service to generate observability data with respect to computing systems of the organization. The monitoring service can monitor servers, databases, tools, and services pertaining to the computing system of the organization. The monitoring service can generate observability data with respect to computer-executable code that is executing on-premises of the organization (in computing devices maintained and operated by the organization) or in a public or private cloud computing environment. Observability data that is generated by the monitoring service includes metrics, logs, and traces. Metrics are measured values of data over intervals of time. A log is a string from a microservice or application running on an on-premises server or in a remote environment (a cloud computing environment) and stored in a suitable format (such as JSON). A trace is alphanumeric text that identifies a sequence of events that represents end to end flow of a transaction, such as a transaction completed between microservices of the organization, a transaction between a microservice and a computing system of a vendor, and so forth.

Briefly, described herein are technologies pertaining to populating fields of a processing record (such as a record of processing activity (ROPA)) based upon observability data generated by a monitoring service. Also described herein are technologies pertaining to identifying how a computing system of an organization alters, over time, with respect to processing personal data of users. In yet another example, technologies described herein pertain to utilizing both observability data generated by a monitoring service and data output by a static code analysis tool to ascertain how a computing system of an organization processes personal data. In still yet another example, the technologies described herein pertain to ensuring that users have consented to processing of personal data for purposes specified by the vendors. Still further, the technologies described herein relate to ensuring that an organization does not violate a data processing policy (specified in an internal policy document, in a contract between the organization and a vendor, etc.) based upon observability data generated by a monitoring service.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a functional block diagram of an analysis computing system that processes observability data generated by a monitoring service in connection with performing a data privacy, data protection, and/or data governance operation.

FIG. 2 is a functional block diagram of an analysis system.

FIG. 3 is a schematic that illustrates operation of a record populator module.

FIG. 4 is a schematic that illustrates operation of a diff analyzer module.

FIG. 5 is a schematic that illustrates operation of a multivariate signal analyzer module.

FIG. 6 is a schematic that illustrates operation of a consent tracker module.

FIG. 7 is a schematic that illustrates operation of an enforcement module.

FIG. 8 is a flow diagram that depicts a method for populating a data processing record with a value that is based upon observability data generated by an observability system.

FIG. 9 is an example computing system.

### DETAILED DESCRIPTION

Various technologies pertaining to processing observability data in connection with performing an operation related to data privacy, data protection, and/or data governance are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “component”, “system”, and “module” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices. Further, as used herein, the term “exemplary” is intended to mean serving as an illustration or example of something and is not intended to indicate a preference.

Described herein are various technologies pertaining to generating output that is indicative of data privacy or data governance with respect to data processed by a computing system of an organization, where the output is generated based upon observability data generated by a monitoring service. Examples of such technologies will be set forth in greater detail below.

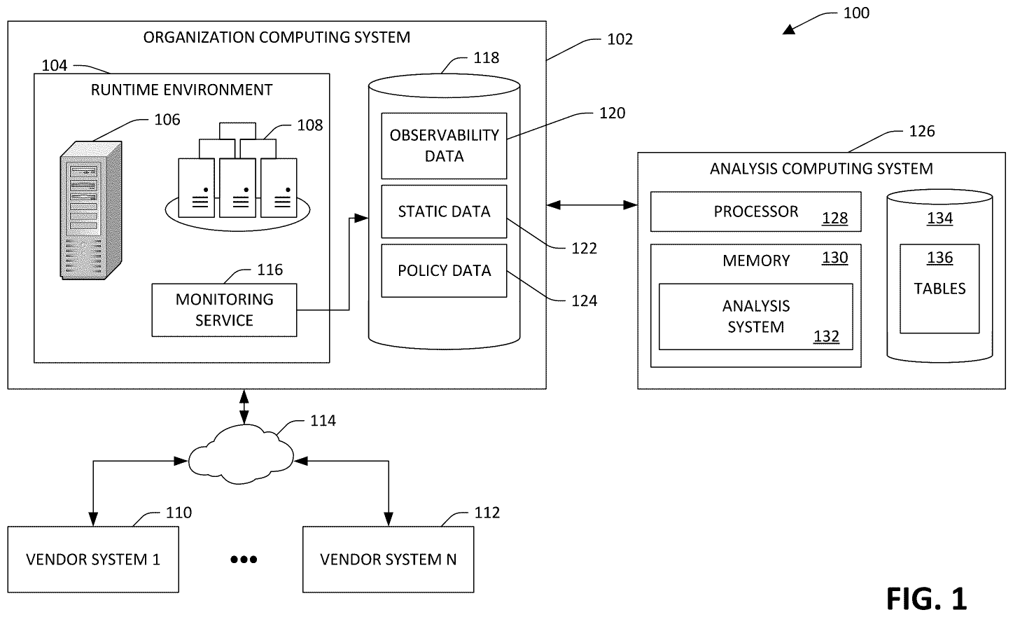

With reference now to FIG. 1, a computing environment 100 is depicted. The computing environment 100 includes an organization computing system 102. The organization computing system 102 has a runtime environment 104, where the runtime environment 104 is the environment in which a program, application, microservice, etc. is executed. The runtime environment 104 includes hardware and software infrastructure that supports the running of a codebase of an organization in real-time. As illustrated in FIG. 1, the runtime environment 104 can include an on-premises server 106, computing device(s) in a data center 108, software executing on the computing devices that supports execution of applications, programs, microservices, etc. of the organization, and so forth. The codebase of the organization, as referenced previously, may be relatively complex. For instance, the codebase may include proprietary code executing on the server 106, may include open-source code executing on a computing device of the data center 108, etc.

The organization computing system 102 can be in communication with vendor systems 110-112 by way of a suitable network 114. Vendor systems, for example, may provide functionality not provided by the organization computing system 102. For instance, the vendor system 110 can be a payment processing system that processes payments for products purchased by users of the organization (e.g., the organization computing system 102 can pass information to the vendor system 110, and the vendor system 110 can process payment for a product or service based upon such information). In another example, the vendor system 110 can be a communication tool that provides communication services by way of web application programming interfaces (APIs), and the organization computing system 102 can pass data to the vendor system 110 in connection with establishing a communications channel between computing devices. There are numerous types of vendor systems. Other vendor systems will be apparent to one of ordinary skill in the art.

A monitoring service 116 executes in the runtime environment 104, where the monitoring service 116 generates observability data with respect to the codebase of the organization as portions of such codebase are executed in the runtime environment 104. The monitoring service 116 can generate observability data with respect to portions of the codebase executing on the server 106, portions of the codebase executing in the cloud (in the data center 108), or at any other computing device of the organization computing system 102. Observability data generated by the monitoring service 116 includes metrics, logs, and traces. A metric is a measured value of data over an interval of time. A log is a string for a microservice, application, or program executing in the runtime environment 104. A trace is a string that identifies a sequence of events for an end-to-end flow of a transaction. Examples of metrics, logs, and traces will be provided herein.

The organization computing system 102 additionally includes a data store 118. The data store 118 stores observability data 120 generated by the monitoring service 116. For example, the monitoring service 116 can output a stream of observability data as portions of the codebase of the organization are executed in the runtime environment 104. Such observability data is stored in the data store 118 as the observability data 120. The data store 118 further includes static data 122. The static data 122 is output by a static analysis tool (not shown) that is provided with source code of the codebase of the organization as input. The data store 118 can further include policy data 124. The policy data 124 can specify constraints with respect to processing of data of particular data types, constraints with respect to transmission of data or particular data types, constraints with respect to locations where data of specified types can be processed, and so forth. The policy data 124 can be extracted from internal policy documents of the organization, from contracts between the organization and vendors or customers of the organization, and so forth. In another example, the policy data can include policies that are explicitly set forth by a DPO of the organization. In yet another example, the policy data 124 can include constraints specified by regulations and/or statutes of jurisdictions where the organization conducts business.

The computing environment 100 further includes an analysis computing system 126 that is in communication with the organization computing system 102. In an example, the analysis computing system 126 is managed by an enterprise that assists organizations with ensuring that the organizations comply with statutes, regulations, and/or policies and contracts when processing certain types of data (e.g., personal data). While the analysis computing system 126 is illustrated as being separate from the organization computing system 102, in another embodiment the organization computing system 102 includes the analysis computing system 126. In another example, an enterprise that provides the monitoring service 116 can provide the functionality described herein as being performed by the analysis computing system 126.

The analysis computing system 126 includes a processor 128 and memory 130, where the memory 130 has an analysis system 132 loaded therein that is executed by the processor 128. The analysis computing system 126 obtains the observability data 120, the static data 122, and/or the policy data 124 from the organization computing system 102. For instance, the analysis computing system 126 periodically retrieves the observability data 120 from the organization computing system 102.

The analysis computing system 126 further includes a data store 134 that has a set of tables 136 stored therein. Example tables are described in greater detail below. The analysis system 132, based upon the obtained observability data 120 (generated by the monitoring service 116), generates output pertaining to data privacy and/or data governance with respect to the codebase executed in the runtime environment 104 of the organization computing system 102. Different types of analysis performed by the analysis system 132 are described in greater detail below.

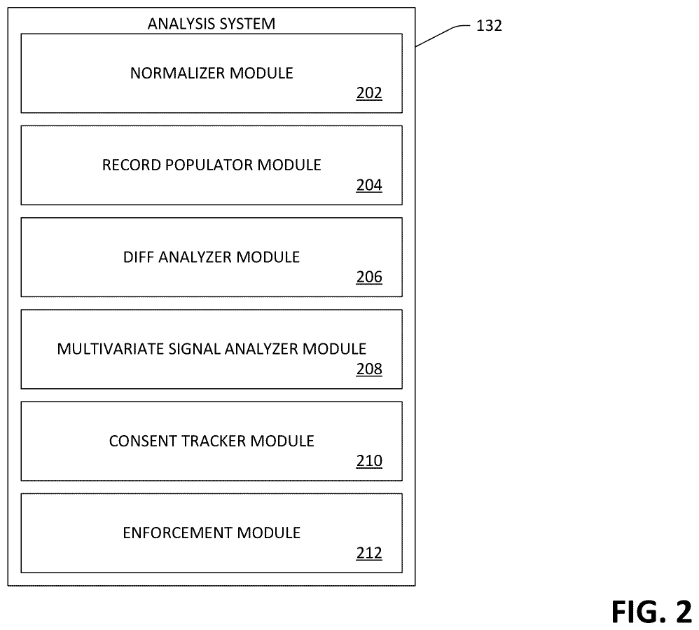

With reference now to FIG. 2, a functional block diagram of the analysis system 132 is illustrated. The analysis system 132 includes a normalizer module 202 that normalizes obtained observability data. For example, the normalizer module 202 receives the observability data 120 in the format produced by the monitoring service 116, extracts content therefrom that is to be used for analysis, and places such content into a format that is suitable for processing, such as JSON, XML, or the like.

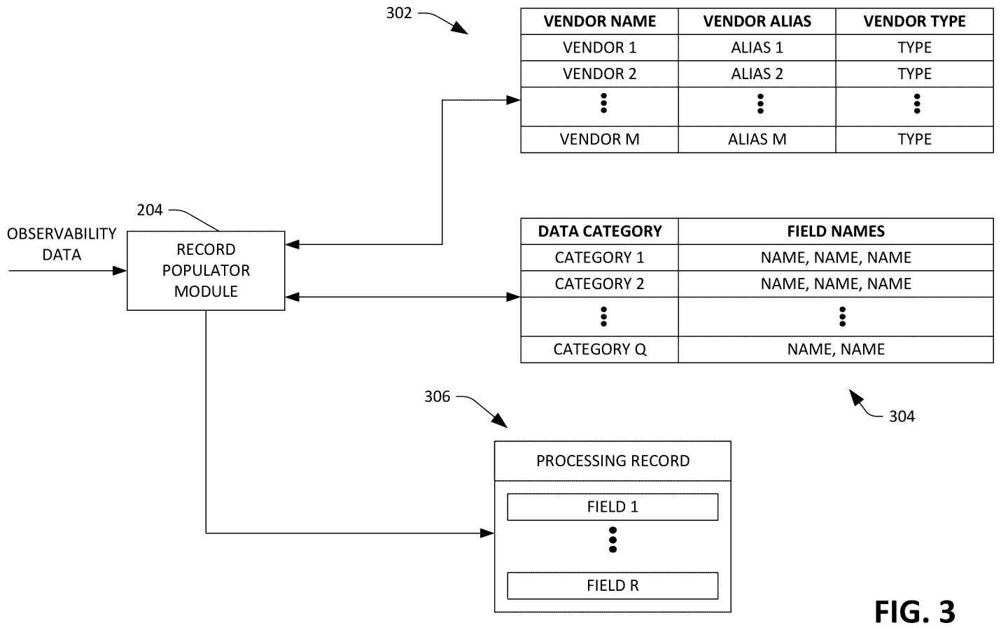

The analysis system 132 further includes a record populator module 204 that populates fields of a processing record based upon the observability data 120 generated by the monitoring service 116 and one or more of the tables 136. FIG. 3 is a schematic that illustrates operation of the record populator module 204. The record populator module 204, generally, is configured to keep processing records (such as ROPAs) up-to-date based upon the observability data 120. For instance, under the European Union (EU) general data protection regulation (GDPR), a business that possesses personal data must maintain a ROPA for presentment to an authority upon request. Briefly, a ROPA is a record that identifies personal data that an organization processes, how such personal data is being used, where the personal data is transferred, how long the personal data is retained, and techniques used to protect the personal data. Therefore, for instance, a ROPA may include a vendor name or service name, a category of personal data, and a geographic location pertaining to the personal data. Currently, organizations create these records manually using spreadsheets. Challenges with this approach include but are not limited to: 1) the fact that an organization may change a type of personal data being processed (this change must be communicated and updated in the spreadsheets, which may be very challenging in fast moving environments); and 2) the fact that collecting and keeping record of types of personal data used across different units of an organization can be challenging.

The record populator module 204 populates fields of a processing record, such as a ROPA, based upon the observability data 120 (metrics, logs, and traces) and a subset of the tables 136. Specifically, the record populator module 204 receives the (normalized) observability data 120 and utilizes a vendor table 302 and a data category table 304 to identify relevant information from the observability data 120. The vendor table 302 includes a list of known vendors that may have computing systems that are in communication with the organization computing system 102. In addition, the vendor table 302 includes aliases of the vendors and optionally types of the vendors (which may be requested in a ROPA). A vendor type is a type of vendor; for instance, the type can be “vendor” or “open source”. The data category table 304 includes a list of data categories and names commonly found in observability data for those data categories. Example data categories include, but are not limited to location, e-mail, telephone number, Social Security number, name, and so forth. For the data category “location”, example names may include “geo_location”, “location”, “ip_address”, “net.ip”, or “cluster-location”. In another example, for the data category “email”, names may include “email”, “e-mail”, “emailid”, or “email_id”.

The analysis system 132 can obtain the observability data 120 by way of an HTTP request or other suitable communication mechanism. While the observability data 120 is depicted as being included in the organization computing system 102, it is to be understood that the observability data 120 for the organization computing system 102 may be stored elsewhere (e.g., at a computing device of the organization that provides the monitoring service 116). These sources from which the observability data 120 are obtained may be software as a service (SaaS)-based application performance monitoring (APM)/observability tools/vendors that provide an HTTP REST API interface. The observability data 120 may also be collected from cloud storage locations.

As noted above, the observability data 120 includes metrics, logs, and traces. An example metric can be as follows:

```
{
  ‘from’: ‘1661904640’,
  ‘metrics’: [
      ‘vendorA.recent_tickets’,
      ‘vendorA.ticket.count’,
      ‘vendorB.bandwidth.all’,
      ‘vendorB.bandwidth.cached’,
      ‘vendorC.binlog.cache_disk_use’,
      ‘vendorC.binlog.cache_use’
    ]
}
```

An example log is as follows:

```
  {
    “id”: “123-ABC”,
    “content”: {
      “timestamp”: “2022-09-01T21:05:46.268Z”,
      “tags”: [
        “env:prod”,
        “docker_image:authenticate:tag”,
        “pod_name:shippingservice-d79d57777-
14t7w”,
        “service:authenticate”,
        “cluster-location: us-central1-c”,
        “zone:us-central1-c”
      ],
      “service”: “authenticate”,
      “message”: “[GetQuote] Authentication request
received”,
    }
  }
```

Most logs include a “message” field, the contents of which may be helpful to understand the purpose that data is flowing through the organization computing system 102. Context fields, like the “tags” field, often provide information such as a process name (in this example, “authenticate”) and a location of processing (in this example, “us-central1-c”), which are to be included in a ROPA.

An example trace is set forth below:

```
  {
    “root”: {
      “id”: “1”,
      “type”: “http”,
      “system”: “http:auth”,
      “kind”: “server”,
      “name”: “frontend”,
      “attrs”: {
        “http.client_ip”: “159.156.101.11”,
        “http.route”: “/api/v1/users/login”,
        “service.name”: “frontend”
      },
      “children”: [
        {
          “id”: “2”,
          “parentId”: “1”,
          “type”: “db”,
          “system”: “db:mysql”,
          “name”: “authenticate”,
          “attrs”: {
            “db.sql.tables”: [ “users” ],
            “db.statement”: “SELECT id, user, email, bio,
image, password_hash FROM users WHERE email =
‘myemailid@email.com’”,
            “service.name”: “authenticate”
          }
        }
      ]
    }
  }
```

Trace data tends to be presented in nested JSON format, representing parent and child relationships. The normalizer module 202 can obtain the raw trace and convert that into a common format, as indicated previously.

The record populator module 204 extracts relevant information from metrics, logs, and traces as follows. With respect to metrics, the record populator module 204 extracts vendor aliases from fields in such metrics and searches the vendor table 302 for the vendor aliases. When a value of the vendor alias extracted from the metric matches a vendor alias in the vendor table 302, the record populator module 204 assigns the vendor type associated with the vendor alias in the vendor table 302 to the vendor alias extracted from the metric. The record populator module can update a field in a processing record 306 to identify the vendor and type of the vendor.

With respect to the logs, the field populator module 204 searches the logs for fields that match the field names in the data categories table 304. With respect to the example log set forth above, the record populator module 204 can ascertain that the log includes the field name “cluster-location”, which is a known name for the “location” data category. The record populator module 204 can also identify the service from the log file, where the service is associated with the data category. In this example, the service is “authenticate”. Thus, the record populator module 204 can update a field of the processing record 306 to indicate that the service “authenticate” processes data at a particular location extracted from the log.

With respect to traces, the record populator module 204 can read the trace data from a trace that identifies processes/microservices and relationship of data flow among different microservices (and different data types that are being exchanged). For example, the record populator module 204, based upon the trace set forth above, can generate the following:

```
  [
    ″1″: {
        ″service-name″: ″frontend″,
        ″parent-id″: 0, # this entry does not have a parent
        ″children-ids″: [ ″2″ ],
        ″operation-type″: ″HTTP POST″,
        ″operation″: ″POST /api/v1/user/login″
  “Client-ip”: 159.156.101.11
      },
    ″2″: {
        ″service-name″: ″authenticate″,
        ″parent-id″: 1,
        ″children-ids″: [ ],
        ″operation-type″: ″sql″,
        ″operation″: ″SELECT id, user, email, bio, image,
password_hash FROM users WHERE id″
      }
  ]
```

The record populator module 204 parses the data around each of the “service name”, “operation type”, and “operation” to determine the following: 1) a name of the process (“frontend” and “authenticate”); 2) categories of data flowing in the system; 3) a location based upon an IP address; and 4) direction of the data flow. The record populator module 204 can include such information in fields of the processing record 204.

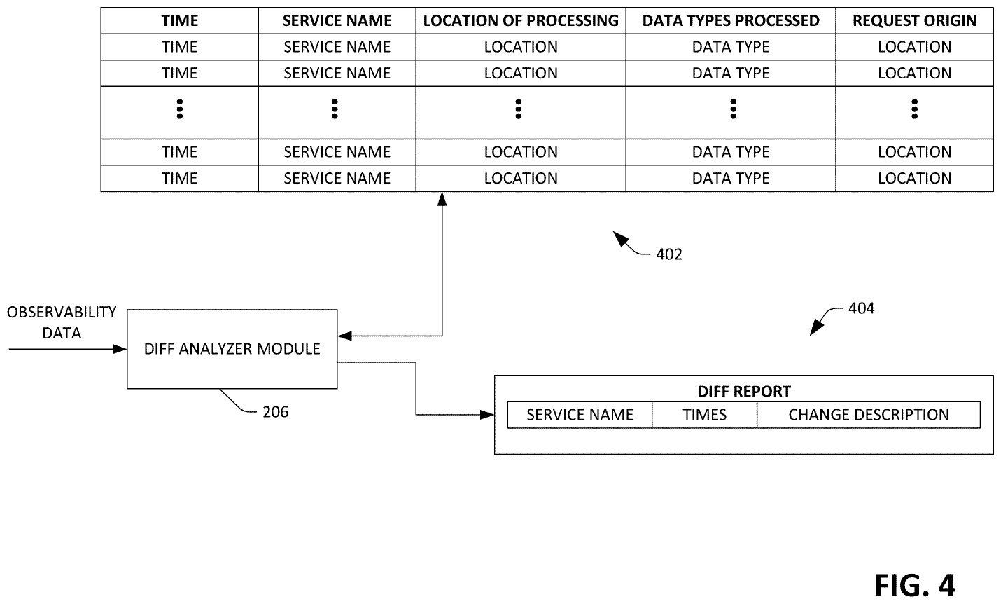

Returning to FIG. 2, the analysis system 132 further includes a diff analyzer module 206 that generates alerts to inform an analyst (e.g., a DPO) when the observability data 120 indicates a change in how particular types of data are processed. FIG. 4 is a schematic that depicts operation of the diff analyzer module 206. As noted above, the analysis system 132 can periodically obtain the observability data 120. The diff analyzer module 206 can analyze logs and traces for the following information, and can construct a table 402 to represent such information: 1) identity of a service (service name); 2) locations where the service is running (location of processing); 3) API endpoints being serviced by the service (not shown); 4) types of data being processed by the process (data types processed); and 5) traffic locations being serviced by the process (request origin).

The diff analyzer module 206 updates the table 402 in times-series fashion and generates a diff report 404 for provision to an analyst when there is an alteration that may be of interest to the analyst. For instance, when the table 402 indicates that a service was previously processing data at a first location but is now processing data at the second location, the diff analyzer module 206 can identify such change and construct the diff report 404 to inform the analyst of the change.

An example log with respect to a service “authenticate” is set forth below:

```
  {
    “id”: “123-ABC”,
    “content”: {
      “timestamp”: “2022-09-01T21:05:46.268Z”,
      “tags”: [
        “env:prod”,
        “docker_image:authenticate:tag”,
        “pod_name:shippingservice-d79d57777-
14t7w”,
        “service:authenticate”,
        “cluster-location: us-central1-c”,
        “zone:us-central1-c”
      ],
      “service”: “authenticate”,
      “message”: “[GetQuote] Authentication request
received”,
    }
  }
```

In this example, the diff analyzer module 206 extracts the timestamp, the service name, and the location of processing from the log, and updates the table 402 with such information. The diff analyzer module 206 can then determine if the newly added information includes a difference with respect to previous information. The diff analyzer module 206 can generates the diff report 404 upon identifying the difference, where the differ report 404 can include the service name, times associated with a change, and a description of the change (that the location of processing has changed).

Returning again to FIG. 2, the analysis system 132 also includes a multivariate signal analyzer module 208 that enriches information that can be ascertained from metrics, logs, and traces, where such information is enriched based upon the static data 122. As noted above, the static data 122 includes information output by a static analysis tool when provided with source code of a portion of the codebase of the organization computing system 102.

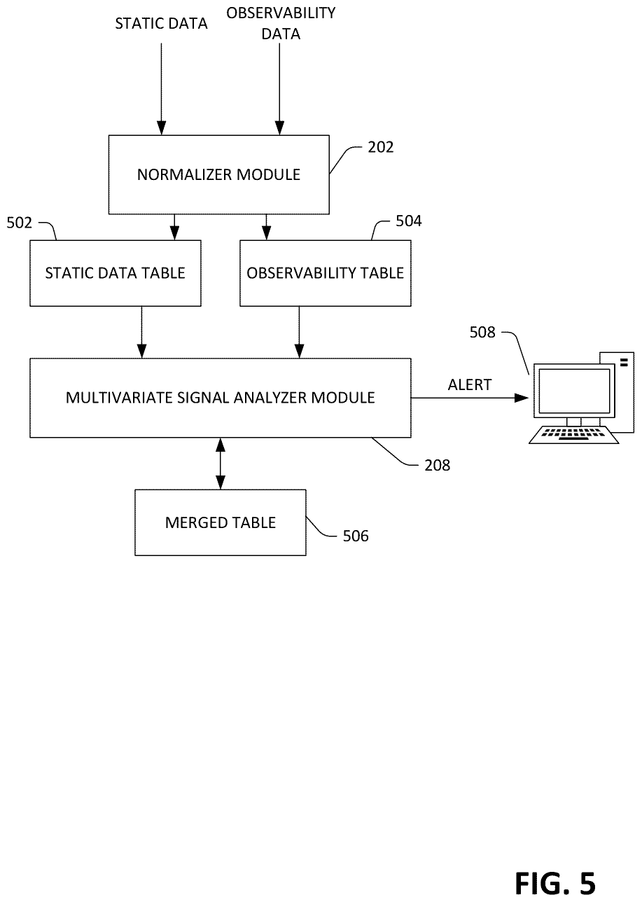

Now referring to FIG. 5, a schematic depicting operation of the multivariate signal analyzer module 208 is presented. The normalizer module 202 receives the static data 122 and the observability data 120 and normalizes such data to place the data in a format suitable for processing. As shown, the normalizer module 202 can generate a static data table 502 that includes information based upon static analysis of the source code. In addition, the normalizer module 202 can generate an observability table 504 based upon the observability data 120 (metrics, logs, and traces). The multivariate signal analyzer module 208 can receive the tables 502 and 504 and generate a merged table 506, where the merged table 506 includes information from the static data table 502 and the observability table 504. Based upon the merging of the aforementioned information, the multivariate signal analyzer module 208 can output an alert to a computing device 508 of an analyst (e.g., a DPO).

With more detail, as noted previously, the observability data 120 provides information as to different components of the codebase of the organization computing system 102. For instance, trace data is structured data that provides information pertaining to transactions performed by the organization computing system 102, identities of microservices that communicate with one another, types of data flows among the microservices, and geographic location where the microservices run. A potential drawback of observability data, however, is that the source code must be instrumented by client libraries that will then send the data to the APM server; hence, there may be gaps in the data that is generated by the APM trace data.

Static code analysis provides information such as identities of data flows among microservices, types of data flowing among microservices (by using high-level signals from source code, such as variable names), identities of vendors (based upon imports being used and vendor client API calls being made). When there is a gap in observability data (caused due to missing instrumentation), such gap can be filled by combining the observability data 120 with the static data 122.

For example, a log messages can indicate that data “uid” is being transmitted to a vendor, and “uid” can appear to be a random string. Reviewing static code analysis data can indicate, however, that:

uid=telephone number+timestamp+random-hash

Therefore, the “uid” string has a telephone number as part of the string, and the multivariate signal analyzer module 208 can alert a DPO that user telephone numbers are being transmitted.

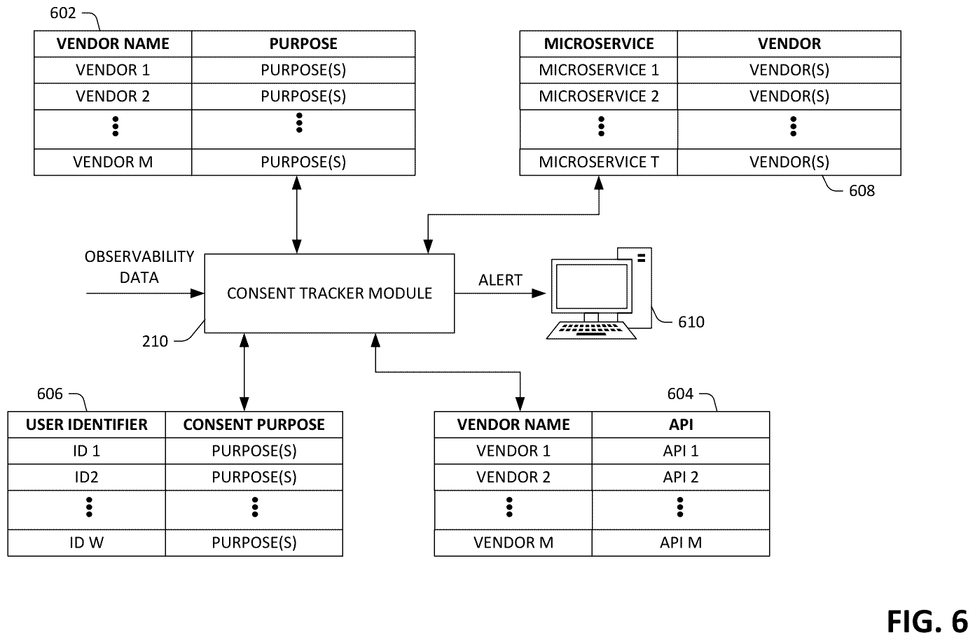

Returning yet again to FIG. 2, the analysis system 132 further includes a consent tracker module 210 that ensures that users have given consent for particular types of data processing. FIG. 6 is a schematic that illustrates operation of the consent tracker module 210.

The consent tracker module 210 detects the “purpose of processing” detection and “validation” for internal microservices/processes using the observability data 120 (logs/metrics/traces) to detect when data is being collected without consent. Logs and traces can be analyzed to identify processes and microservices running in the organization computing system 102. Traces can provide information around what systems are connected to each other and what APIs are being fired by different microservices. This information about what APIs are being served and what APIs calls are being made can help associate the purpose of the business process and also helps do the validation.

The consent tracker module 210 employs tables from the tables 136 to perform consent tracking. A purposes table 602 maps vendor names to a categorization, where the categorization for a vendor corresponds to purpose of the vendor (example categorizations can be “recruiting”, “marketing”, “support”, “customer enhancement”, etc. A vendor API table 604 maps a vendor name to API endpoints that the vendor supports. A consent table 606 includes user identifiers and purposes for which the users have given consent. For instance, a user identifier can be an email address, and the consent table 606 can indicate that the user associated with the email address has authorized processing of personal data for the categorization of “recruitment”.

The consent tracker module 210 obtains the observability data 120 and identifies (in the observability data 120) REST API calls by microservices. The consent tracker module 210 searches the vendor API table 604; when the vendor API is included in the vendor API table 604, the consent tracker module 210 updates a mapping table 608 to indicate that the microservice is associated with the vendor mapped to the vendor API in the vendor table 604. The consent tracker module 210 searches the purpose table 602 based upon the vendor mapped to the microservice and assigns the microservice to the purpose in the mapping table 608 (not shown). The user identifier is then checked in the consent table 606 to determine whether the user has consented to use of the data for such purpose. When the consent tracker module 210 determines that the user has not consented, the consent tracker module can transmit an alert to a computing system 610 of an analyst (e.g., DPO).

An example is as follows:

```
  {
    “root”: {
      “id”: “1”,
      “type”: “http”,
      “system”: “http:auth”,
      “kind”: “server”,
      “name”: “job-app-frontend”,
      “attrs”: {
        “http.client_ip”: “159.156.101.11”,
        “http.route”: “/submit-resume”,
        “service.name”: “job-app-frontend”
      },
      “children”: [
        {
          “id”: “2”,
          “parentId”: “1”,
          “type”: “client”,
          “system”: “http”,
          “name”: “job-app-backend”,
          “attrs”: {
  “http.route”: “https://app.greenhouse.com/api/submit-
profile”,
  “http.user.id”: “user@email.com”,
          }
        }
      ]
    }
  }
```

In the above example, “job-app-backend” acts as a client and connects to “https://app.greenhouse.com”, so “job-app-backend” will be associated with vendor “GreenHouse”. User Id: “user@email.com” will be associated as “Job Applicant” and so is looked up in the database for consent.

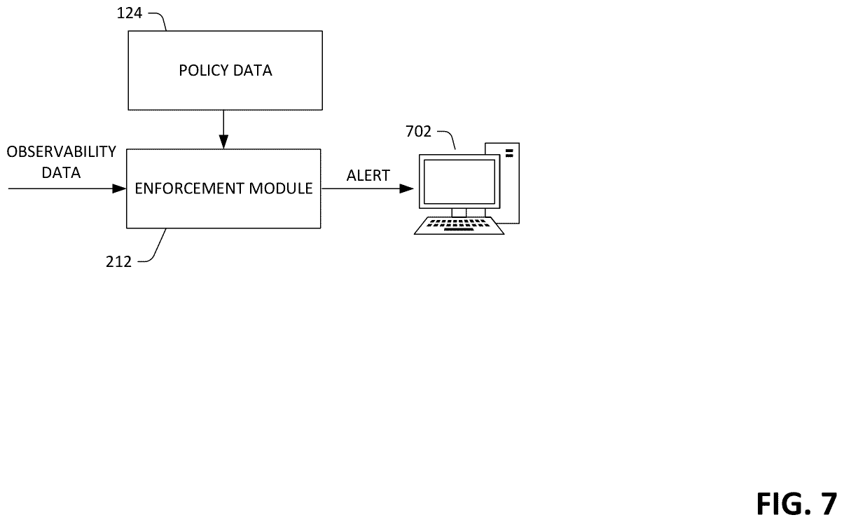

Returning yet again to FIG. 2, the analysis system 132 also includes an enforcement module 212 that outputs an alert when a policy (with respect to processing of data of a particular type) is violated. FIG. 7 is a schematic that illustrates operation of the enforcement module 212. The enforcement module 212 receives the policy data 124 and the observability data 120. While the policy data 124 and observability data 120 are illustrated as being includes in the same data store, it is to be understood that the policy data 124 and the observability data 120 may be stored at separate locations, where one or more of the locations may not be under control of the organization that manages the organization computing system.

A policy with respect to a vendor can be expressed in JSON format—an example of policy data is as follows:

```
{
  “vendors”: [
    “VENDORA”: {
        “datatypes”: [ “email”, “phone” ],
        “location-of-processing”: [ “eu” ]
      }
  ],
  “systems”: [
    “checkoutservice”: {
        “datatypes”: [ “email”, “creditcard” ],
        “location-of-processing”: [ “us” ]
    }
  ]
}
```

In the above example, policies for “vendors” and “systems” are expressed in the policy data 124. Specifically, a policy for vendor “VENDORA” notes that such vendor can process “email” and “phone”; however, “VENDORA” is not authorized to process any other data types. A policy for “systems” notes that a process/microservice/system named “checkoutservice” is authorized to process “email” and “credit card” data types; however, “system” is not authorized to process any other data types.

The enforcement module 212 obtains the observability data 120 and searches the observability data 120 for the vendor “VENDORA” (through a vendor alias, searching for an API associated with the vendor, etc.). The enforcement module 212 then ascertains data types being passed to the vendor and surfaces an alert to a computing device 702 of an analyst when the enforcement module 212 determines that the vendor is being provided with data that such vendor is not authorized to receive. The enforcement module 212 undertakes a similar process with respect to the “checkoutservice” process/microservice/system.

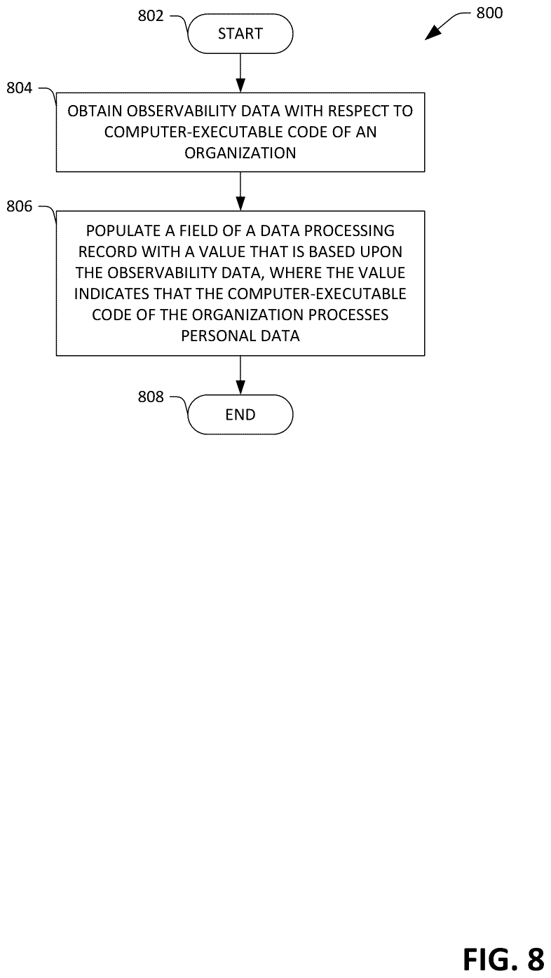

Referring to FIG. 8, a methodology 800 is set depicted, where the methodology 800 is described as being a series of acts that are performed in a sequence; it is to be understood and appreciated, however, that the methodology is not limited by the order of the sequence. For example, some acts can occur in a different order than what is described herein. In addition, an act can occur concurrently with another act. Further, in some instances, not all acts may be required to implement a methodology described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

The methodology 800 starts at 802, and at 804 observability data is obtained with respect to computer-executable code of an organization. The observability data is generated by an observability tool that has access to the computer-executable code (e.g., and can generate trace files, log files, and the like). At 806, a field of a data processing record is populated with a value, where the value is computed based upon the observability data. The value indicates that the computer-executable code of the organization processes personal data (such as names of people, addresses of people, email addresses of people, and so forth). The methodology 800 completed at 808.

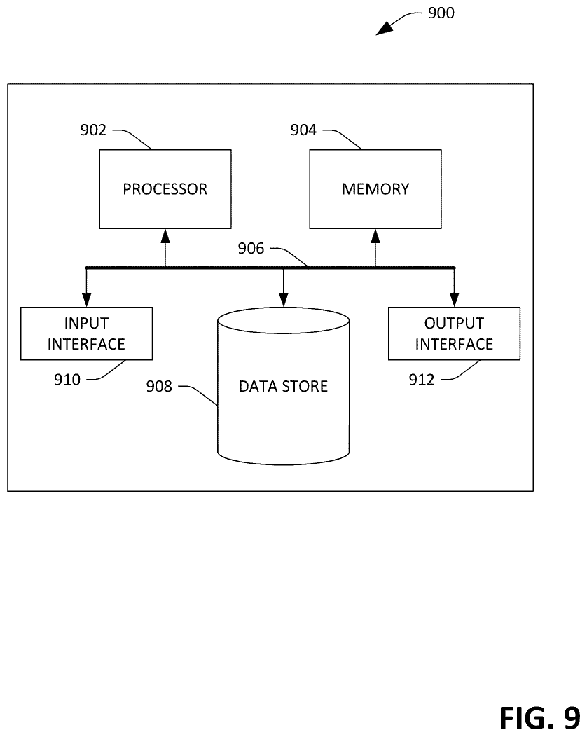

Referring now to FIG. 9, a high-level illustration of an exemplary computing device 900 that can be used in accordance with the systems and methodologies disclosed herein is illustrated. For instance, the computing device 900 may be used in a system that generates observability data. By way of another example, the computing device 900 can be used in a system that analyzes observability data with respect to an operation pertaining to data privacy, data protection, and/or data governance. The computing device 900 includes at least one processor 902 that executes instructions that are stored in a memory 904. The instructions may be, for instance, instructions for implementing functionality described as being carried out by one or more components discussed above or instructions for implementing one or more of the methods described above. The processor 902 may access the memory 904 by way of a system bus 906. In addition to storing executable instructions, the memory 904 may also store observability data, static data, policy data, tables, etc.

The computing device 900 additionally includes a data store 908 that is accessible by the processor 902 by way of the system bus 906. The data store 908 may include executable instructions, observability data, policy data, static data, etc. The computing device 900 also includes an input interface 910 that allows external devices to communicate with the computing device 900. For instance, the input interface 910 may be used to receive instructions from an external computer device, from a user, etc. The computing device 900 also includes an output interface 912 that interfaces the computing device 900 with one or more external devices. For example, the computing device 900 may display text, images, etc. by way of the output interface 912.

It is contemplated that the external devices that communicate with the computing device 900 via the input interface 910 and the output interface 912 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 900 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 900 may be a distributed system. Thus, for instance, several devices may be in communication by way of a network connection and may collectively perform tasks described as being performed by the computing device 900.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Features pertaining to technologies that facilitate populating data processing records with values have been described herein, where such features conform to the following examples.

(A1) In an aspect, a method performed by a computing system includes obtaining observability data with respect to computer-executable code of an organization, where the observability data is generated by an observability tool that has access to the computer-executable code. The method also includes populating a field of a data processing record with a value based upon the observability data, wherein the value indicates that the computer-executable code of the organization processes personal data.

(A2) In some embodiments of the method of (A1), the observability data comprises a log generated by the observability tool, wherein the log is a string generated by a microservice in the computer-executable code.

(A3) In some embodiments of the method of at least one of (A1)-(A2), the observability data comprises a trace generated by the observability tool, wherein the trace is alphanumeric text that identifies a sequence of events that represents end to end flow of a transaction between microservices of the computer-executable code.

(A4) In some embodiments of the method of at least one of (A1)-(A3), the observability data comprises a metric, wherein the metric is a measured value of data over a predefined interval of time.

(A5) In some embodiments of the method of at least one of (A1)-(A4), the method also includes populating multiple fields of the data processing record with respective values based upon the observability data, wherein the values are indicative of how the computer-executable code processes personal data of users.

(A6) In some embodiments of the method of at least one of (A1)-(A5), the method also includes obtaining static analysis data for the computer-executable code, where the static analysis data is output by a static analysis tool that is provided with source code pertaining to the computer-executable code as input, wherein the field of the data processing record is populated with the value based upon the static analysis data.

(A7) In some embodiments of the method of at least one of (A1)-(A6), the value in the field of the processing record indicates that a person with respect to whom the personal data pertains has failed to provide consent for a specified purpose that the personal data is processed by the computer-executable code.

(A8) In some embodiments of the method of at least one of (A1)-(A7), the method also includes obtaining a computer-readable document that specifies a policy pertaining to the personal data, wherein the value in the field of the processing record indicates that the policy is violated due to the computer-executable code processing the personal data.

(A9) In some embodiments of the method of at least one of (A1)-(A8), the method also includes obtaining a computer-readable document that comprises an agreement between the organization and a third party with respect to the personal data, wherein the value in the field of the processing record indicates that the agreement is violated due to the computer-executable code processing the personal data.

(A10) In some embodiments of the method of at least one of (A1)-(A9), the value in the field of the processing record indicates that the computer-executable code previously failed to process the personal data.

(B1) In another aspect, a computing system includes a processor and memory, where the memory stores instructions that, when executed by the processor, cause the processor to perform a method disclosed herein (e.g., any of the methods of (A1)-(A10)).

(C1) In still yet another aspect, a computer-readable storage medium includes instructions that, when executed by a processor, cause the processor to perform a method disclosed herein (e.g., any of the methods of (A1)-(A10)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
obtaining observability data with respect to computer-executable code of an organization, where the observability data is generated by an observability tool that has access to the computer-executable code; and
populating a field of a data processing record with a value based upon the observability data, wherein the value indicates that the computer-executable code of the organization processes personal data.

2. The computing system of claim 1, wherein the observability data comprises a log generated by the observability tool, wherein the log is a string generated by a microservice in the computer-executable code.

3. The computing system of claim 1, wherein the observability data comprises a trace generated by the observability tool, wherein the trace is alphanumeric text that identifies a sequence of events that represents end to end flow of a transaction between microservices of the computer-executable code.

4. The computing system of claim 1, wherein the observability data comprises a metric, wherein the metric is a measured value of data over a predefined interval of time.

5. The computing system of claim 1, the acts further comprising populating multiple fields of the data processing record with respective values based upon the observability data, wherein the values are indicative of how the computer-executable code processes personal data of users.

6. The computing system of claim 1, the acts further comprising:
obtaining static analysis data for the computer-executable code, where the static analysis data is output by a static analysis tool that is provided with source code corresponding to the computer-executable code as input, wherein the field of the data processing record is populated with the value based upon the static analysis data.

7. The computing system of claim 1, wherein the value in the field of the processing record indicates that a person with respect to whom the personal data pertains has failed to provide consent for a specified purpose that the personal data is processed by the computer-executable code.

8. The computing system of claim 1, the acts further comprising:
obtaining a computer-readable document that specifies a policy pertaining to the personal data, wherein the value in the field of the processing record indicates that the policy is violated due to the computer-executable code processing the personal data.

9. The computing system of claim 1, the acts further comprising:
obtaining a computer-readable document that comprises an agreement between the organization and a third party with respect to the personal data, wherein the value in the field of the processing record indicates that the agreement is violated due to the computer-executable code processing the personal data.

10. The computing system of claim 1, wherein the value in the field of the processing record indicates that the computer-executable code previously failed to process the personal data.

11. A method performed by a computing system, the method comprising:
obtaining observability data with respect to computer-executable code of an organization, where the observability data is generated by an observability tool that has access to the computer-executable code; and
populating a field of a data processing record with a value based upon the observability data, wherein the value indicates that the computer-executable code of the organization processes personal data.

12. The method of claim 11, wherein the observability data comprises a log generated by the observability tool, wherein the log is a string generated by a microservice in the computer-executable code.

13. The method of claim 11, wherein the observability data comprises a trace generated by the observability tool, wherein the trace is alphanumeric text that identifies a sequence of events that represents end to end flow of a transaction between microservices of the computer-executable code.

14. The method of claim 11, wherein the observability data comprises a metric, wherein the metric is a measured value of data over a predefined interval of time.

15. The method of claim 11, further comprising populating multiple fields of the data processing record with respective values based upon the observability data, wherein the values are indicative of how the computer-executable code processes personal data of users.

16. The method of claim 11, further comprising:
obtaining static analysis data for the computer-executable code, where the static analysis data is output by a static analysis tool that is provided with source code pertaining to the computer-executable code as input, wherein the field of the data processing record is populated with the value based upon the static analysis data.

17. The method of claim 1, wherein the value in the field of the processing record indicates that a person with respect to whom the personal data pertains has failed to provide consent for a specified purpose that the personal data is processed by the computer-executable code.

18. The method of claim 11, further comprising:
obtaining a computer-readable document that specifies a policy pertaining to the personal data, wherein the value in the field of the processing record indicates that the policy is violated due to the computer-executable code processing the personal data.

19. The method of claim 11, further comprising:
obtaining a computer-readable document that comprises an agreement between the organization and a third party with respect to the personal data, wherein the value in the field of the processing record indicates that the agreement is violated due to the computer-executable code processing the personal data.

20. A computer-readable storage medium comprising instructions that, when executed by a processor, cause the processor to perform acts comprising:
obtaining observability data with respect to computer-executable code of an organization, where the observability data is generated by an observability tool that has access to the computer-executable code; and
populating a field of a data processing record with a value based upon the observability data, wherein the value indicates that the computer-executable code of the organization processes personal data.
